(19) United States
(12) Patent Application Publication
(10) Pub. No.: US 2005/0067024 A1
(43) Pub. Date: Mar. 31, 2005

(54) Reverse-flow throttle valve

(76) Inventors: Herbert Strahberger, Gallne ukirchen (AT); Franz Wippel, Kirnberg (AT)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/869,865

(22) Filed: Jun. 18, 2004

(30) Foreign Application Priority Data
Sep. 25, 2003 (DE) 1 03 44 593.5

(51) Int. Cl. F16K 15/04

(52) U.S. Cl. 137/539

(57) ABSTRACT

A reverse-flow throttle valve and a high-pressure injection system equipped with the reverse-flow throttle valve in which the valve is seated in a through bore of the rail and is thus disposed in the fuel flow between the rail volume and the injector line leading to the fuel injector.

### BACKGROUND OF THE INVENTION

1. Field of the Invention

The invention relates to a reverse-flow throttle valve for a high-pressure fuel injection system. High-pressure fuel injection systems, in particular so-called common rail systems, have proved themselves extremely well for some years, both in mass production and in use. They have contributed quite substantially to the successful course of the modern Diesel engine in the passenger car, which is gaining more and more market share. In terms of torque and fuel consumption, Diesel engines can easily be compared with the best gasoline engines and are already superior to them. However, for Diesel engines for passenger car applications, especially stringent demands in terms of comfort and quietness are made. Improvements are therefore always welcome, so as to achieve further optimization in terms of those parameters.

2. Description of the Prior Art

A reverse-flow throttle valve, hereinafter sometimes abbreviated as RDV, is known from the book entitled Diesel Engine Management, Robert Bosch GmbH, Second Edition 1999, page 273. The reverse-flow throttle valve essentially includes a metal housing embodied as a hollow cylinder, with a male thread on one end piece and a female thread on the other end piece. The reverse-flow throttle valve is disposed between the high-pressure line (rail) and the fuel injector, and damps troublesome pressure fluctuations in the injection system. The reverse-flow throttle valve is screwed into the high-pressure line (rail) with the male thread, and with the female thread, is joined to the fuel injector. The reverse-flow throttle valve has a through opening on each side and thus makes a fuel flow from the rail to the fuel injector possible. In the interior of the housing, a piston loaded by a compression spring is slidably supported; in its position of repose, it closes the connection opening to the high-pressure line. In the working position, the piston is moved out of its position of repose counter to the pressure of the compression spring and thus makes it possible for fuel to flow from the rail to the fuel injector. The known reverse-flow throttle valve is complicated in construction and requires a pressuretight housing that can withstand the high rail pressure on the order of magnitude of about 1600 bar or more.

### OBJECT AND SUMMARY OF THE INVENTION

The reverse-flow throttle valve designed according to the invention is distinguished by having only a few simple components which are simple to manufacture and to assemble. Because the reverse-flow throttle valve is integrated directly with the rail, specifically in a through bore that leads to the fuel injector, a high-pressure-proof housing with threaded connections on both sides of the housing can be dispensed with. This enhances operating safety, since it eliminates possible leaks. Mounting the reverse-flow throttle valve in the rail can be done simply, since it is disposed in a through bore of the rail. The interface between the rail and the line leading to the fuel injector is preserved essentially unchanged. The embodiment according to the invention is thus advantageously compatible with systems that have already been introduced into mass production.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 is a longitudinal sectional view of a first variant embodiment of a reverse-flow throttle valve according to the invention;

FIG. 2.1 is a cross section through the reverse-flow throttle valve taken along the line II.I-II.I in FIG. 1;

FIG. 2.2 is a cross section through the reverse-flow throttle valve taken along the line II.II-II.II in FIG. 1;

FIG. 3 shows a cross section through a rail;

FIG. 4 shows a rail with a reverse-flow throttle valve disposed in a through bore of the rail;

FIG. 5 shows essential components of a high-pressure injection system;

FIG. 6 shows a second variant embodiment of a reverse-flow throttle valve in a longitudinal section; and

FIG. 7 is a cross section taken along the line VII-VII of FIG. 6.

### DESCRIPTION OF THE PREFERRED EMBODIMENTS

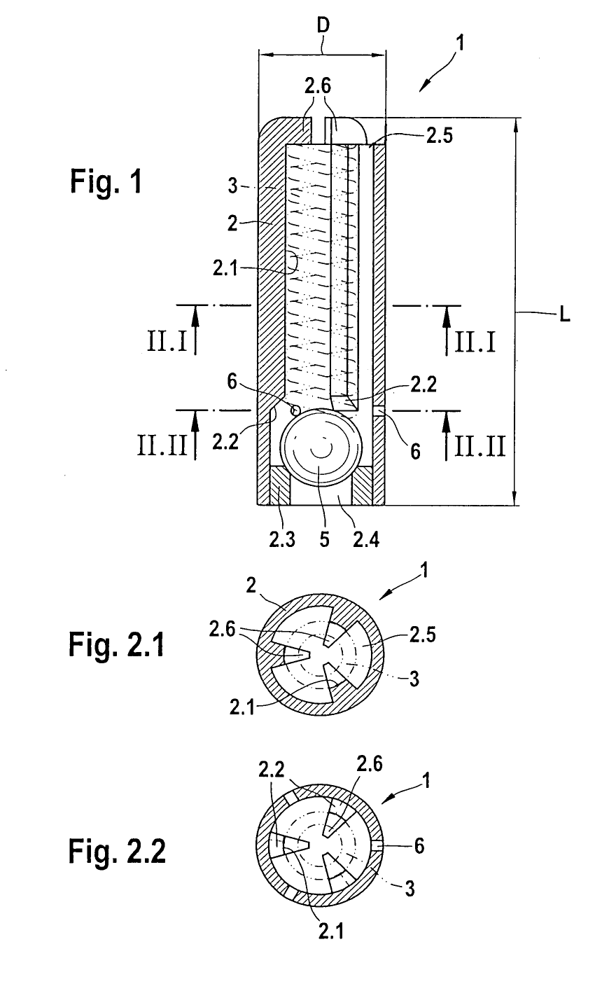

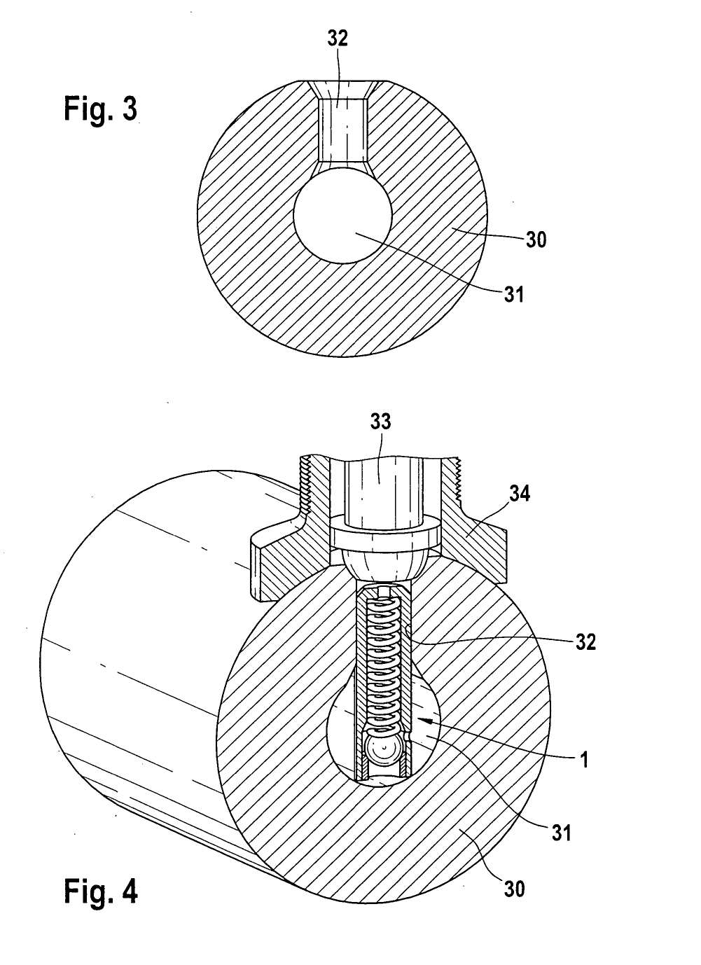

FIG. 1 shows a first variant embodiment of a reverse-flow throttle valve (RDV) 1 in a longitudinal section. The reverse-flow throttle valve includes a cylindrical housing 2 embodied as essentially cup-shaped. A compression spring 3 is supported in this housing 2 and is guided by the inner wall 2.1 of the housing 2. The compression spring 3 is shown in dot-dashed lenses in FIGS. 2 and 3, and is braced on one end on the bottom of the housing 2 and on the other on a ball 5, which as a result is pressed against a ball seat 2.3. The inner wall 2.1 of the housing 2 is offset in stepped fashion and as a result forms a stop 2.2 for the ball 5. An opening 2.5 is made in the bottom of the housing 2. A bore 2.4 is disposed in the end piece of the housing 2 remote from the bottom, and its inside diameter is defined by the ball seat 2.3. At the level of the line II.II-II.II, at least one throttle bore 6 is made in the housing 2.

FIG. 2.1 shows a cross section through the housing 2 of the reverse-flow throttle valve 1 taken along the line II.I-II.I. It can be seen from the view in FIG. 2.1 that protrusions 2.6 extend over the compression spring 3 disposed inside the housing 2, so that when pressure is exerted on the bore 2.4, the ball 5 is pushed in damped fashion against the stops 2.2 of the housing 2 and uncovers the bore 2.4.

FIG. 2.2 shows a cross section through the reverse-flow throttle valve of FIG. 1 along the line II.II-II.II in FIG. 1.

It can be seen from FIG. 2.2 that three throttle bores 6 in the wall of the housing 2 are offset from one another by an angle of 120°. The protrusions 2.6, which fit over the compression spring 3 received in the interior of the housing 2, are likewise disposed at an angle of 120° from one another. Instead of the three protrusions and three throttle bores 6 shown in FIG. 2.2, it is also possible for there to be two diametrically opposed throttle bores 6 in the wall of the housing 2 and two protrusions 2.6 on the housing 2. The protrusions 2.6 could equally well be offset from one another by 90°, as could the throttle bores 6 embodied in the wall of the housing 2. In an especially simple way in terms of production technology, the throttle bores 6 are designed as cylindrical bores; they can equally well extend conically or have a slotlike geometry.

In other variant embodiments of the invention, instead of a ball 5 as a closure means for the bore 2.4, a cone or a small plate could be provided instead, cooperating with a suitably adapted seat to form a valve. The reverse-flow throttle valve of the invention is distinguished by an especially simple construction. It comprises only very few parts, which can be produced and installed in simple processes. In contrast to convention reverse-flow throttle valves, a pressuretight housing is not required, since the reverse-flow throttle valve embodied according to the invention is disposed directly in a through bore of a rail of a high-pressure injection system, as will be described in further detail below.

FIG. 3 shows a cross section through a rail 30, which is embodied essentially as an elongated hollow cylinder. The rail 30 is embodied with thick walls and is thus designed for high pressure loads, in the range up to about 2000 bar. The thick wall encloses the rail volume 31 that serves to keep fuel at high pressure on hand. A through bore 32 which serves to receive the reverse-flow throttle valve 1 of FIG. 1 is made in the wall of the rail 30, perpendicularly to the longitudinal axis of the rail 30.

The installed position of the reverse-flow throttle valve 1 will now be described in conjunction with FIG. 4 which is a perspective view showing a rail 30 with a reverse-flow throttle valve 1 disposed in the through bore 32 of the rail. The reverse-flow throttle valve 1 is operatively connected to an injector line 33, which is introduced into a connection stub 34. After the injector line 33 has been installed, it is screwed to the connection stub 34 by a union nut, not shown. The connection stub 34 can for instance be welded to the jacket of the rail 30. The reverse-flow throttle valve 1 is thus located in the fuel flow between the rail 30 and a fuel injector 35, not shown in FIG. 4. Because the reverse-flow throttle valve 1 is disposed directly in the rail 30 itself, it is possible, in a departure from the construction of conventional reverse-flow throttle valves, to dispense with a pressuretight housing and pressuretight screw connections. This makes economical mass production of the reverse-flow throttle valve possible. To enable integration with a conventional rail, the reverse-flow throttle valve must have appropriate installation dimensions. In a preferred exemplary embodiment of the invention, the diameter D (see FIG. 1) of the housing 2 of the reverse-flow throttle valve 1 is between about 3.5 mm and 6.5 mm, and in particular is 5 mm. The length L (see FIG. 1) of the housing 2 of the reverse-flow throttle valve 1 is preferably between 12 mm and 18 mm and in particular is 16 mm.

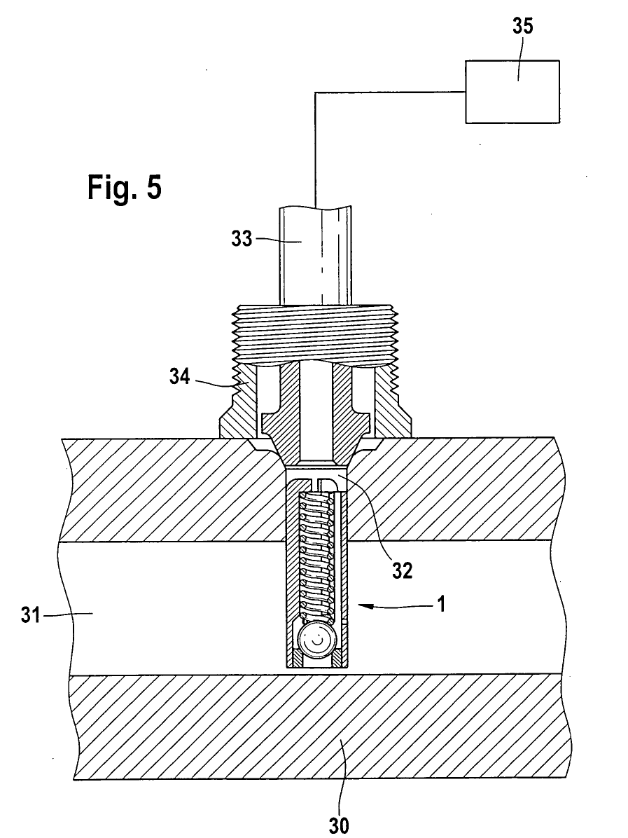

FIG. 5 again shows essential components of a high-pressure injection system. The rail 30, reverse-flow throttle valve 1, and parts of the connection with the fuel injector 35 are shown here in section. The high-pressure injection system includes the rail 30, which encloses a rail volume 31. Via an injector line 33, which communicates in pressuretight fashion with the rail 30 by means of a union nut on the connection stub 34, the rail 30 communicates with a fuel injector 35 that is shown only schematically in the form of a block in FIG. 5. The reverse-flow throttle valve 1 is disposed in a through bore 32 of the rail 30.

The mode of operation of the reverse-flow throttle valve 1 will now be described briefly. In the position of repose (FIG. 1), the valve ball 5, loaded by the compression spring 3, rests on the ball seat 2.3 and closes the bore 2.4, oriented toward the rail volume 31, of the reverse-flow throttle valve 1. As soon as the pressure from the rail volume 31 exceeds the pressure prevailing on sides of the opening 2.5, for instance because this side of the reverse-flow throttle valve is relieved of a pressure, the ball 5 will be lifted from its ball seat 2.3 and moves in the direction of the longitudinal axis of the reverse-flow throttle valve 1, at most as far as the stop 2.2, which prevents it from moving any further. Because the bore 2.4 is now uncovered, fuel at high pressure can flow out of the rail volume 31 into the interior of the housing 2 of the reverse-flow throttle valve 1 and emerge through the opening 2.5 disposed in the bottom of the housing and thus reach the injector line 33, which carries the fuel onward to the fuel injector 35. After the end of the injection event, the force of the compression spring 3 forces the ball 5 back into its position of repose on the ball seat 2.3, as a result of which the bore 2.4 is closed, and the fuel flow out of the rail volume 31 is suppressed. The throttle bore 6 (FIG. 1, FIG. 2.2) continues to be open. Through this throttle bore 6, fuel can be directed back into the rail volume 31 from the injector side, even if the ball 5 is in the closed position. As a result, pressure fluctuations that occur in the system during the injection events can advantageously be damped.

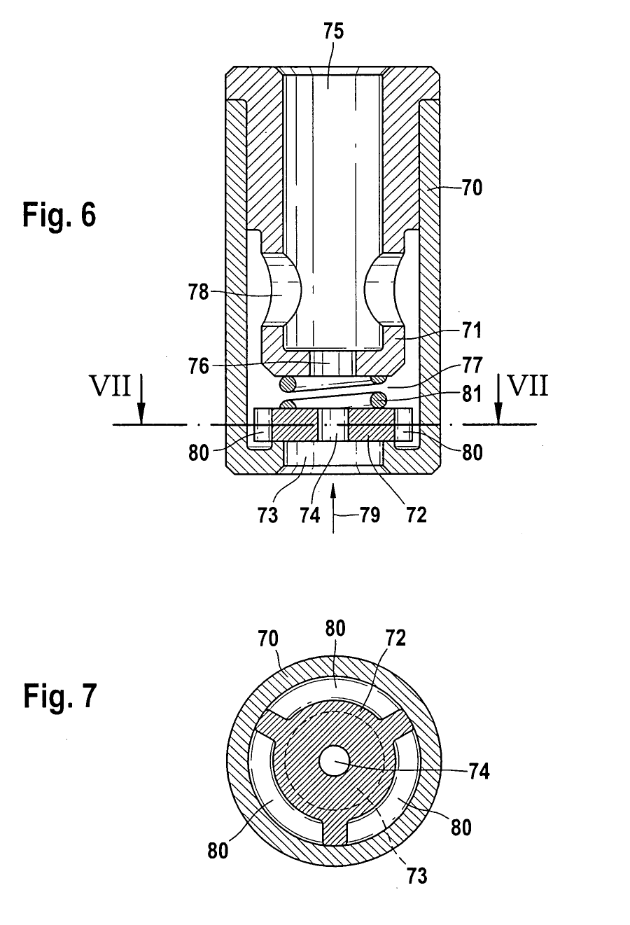

A further variant embodiment of a reverse-flow throttle valve (RDV2) will described below in conjunction with FIGS. 6 and 7. FIG. 6 shows the RDV2 in a longitudinal section. FIG. 7 shows a cross section taken along the line VII-VII in FIG. 6. The RDV2 includes a substantially cup-shaped valve holder 70 and a likewise substantially cup-shaped stroke limiter 71, which is disposed in the interior of the valve holder 70 in such a way that the outer face of the cup bottom of the stroke limiter 71 and the inner face of the cup bottom of the valve holder 70 define an intermediate chamber 77. The valve holder 70 and the stroke limiter 71 can expediently be screwed together by means of a suitable thread. A closure means 72 is disposed in the intermediate chamber 77, where it is supported movably such that in a working position it rests on the outer face of the cup bottom of the stroke limiter 71, while in a position of repose (as shown in FIG. 6), it rests on the inner face of the cup bottom of the valve holder 70. In the variant embodiment RDV2 of a reverse-flow throttle valve shown in FIGS. 6 and 7, the closure means 72 takes the form of a small plate, with a centrally disposed bore 74. Bores 73 and 76 are also disposed in the bottoms of the valve holder 70 and the stroke limiter 71, respectively. In addition, at least one bore 78 is disposed in the wall of the hub 71. As already described above, the RDV2 is likewise disposed directly in a through bore 32 of the rail 30. A spring 81 can be received inside the intermediate chamber 77 and presses the closure means 72, here embodied in platelike or disklike form, against the valve holder 70. On the closure means 72, protrusions separated from one another by recesses 80 are embodied, in order to limit the radial motion of the closure means 72.

The mode of operation of the RDV2 will now be described briefly. The RDV2 experiences a flow of fluid through it in the flow direction represented by the arrow 79. The closure means 72 is lifted from its position of repose on the cup bottom of the valve holder 70 and in its working position rests on the underside of the cup of the stroke limiter 71, and this stroke limiter thus limits the stroke of the closure means 72. The fluid can flow both into the interior of the stroke limiter 71 and out of the opening 75 through the aligned bores 74 and 76 in the bottoms of the valve holder 70 and the stroke limiter 71. Fluid can also flow through the bore 73, now uncovered by the closure means 72, and through the bore 78 into the interior of the stroke limiter 71 and onward to the opening 75. In the blocked state, as shown in FIG. 6, the closure means 72 rests on the cup bottom of the valve body and closes the bore 73, except for a cross section that remains open and is defined by the cross-sectional area of the bore 74. By suitable adaptation of the diameters of the bores 74 and 76, the performance of the RDV2 in the blocked state can be varied by construction. Instead of a blocking means 72 in the form of a small plate, a ball can for instance be used as blocking means in a further variant embodiment, not shown in the drawing. The RDV2 is distinguished by even fewer individual parts and therefore can be produced even more economically.

The reverse-flow throttle valves designed according to the invention are not only economical to produce and install but also enable quieter operation of the internal combustion engine, since because of the damping of the pressure fluctuations, a more-exact mode of operation of the fuel injector 35 is attainable.

The foregoing relates to preferred exemplary embodiments of the invention, it being understood that other variants and embodiments thereof are possible within the spirit and scope of the invention, the latter being defined by the appended claims.

1. A reverse-flow throttle valve (RDV) comprising
a cup-shaped housing (2) having a top and bottom and having one inlet opening and one outlet opening,
closure means for the inlet opening,
a closure means (5, 72), and
a compression spring (3.81) disposed in the housing (2) and having one end braced on the bottom of the housing (2, 70) and the other braced on the closure means (5, 72), the closure means (5, 72) being movable between a first stop (2.2, 71) and a second stop (2.3, 70).

2. The reverse-flow throttle valve in accordance with claim 1, wherein the compression spring (3) rests on the inner wall (2.1) of the housing (2) and is guided by this inner wall (2.1).

3. The reverse-flow throttle valve in accordance with claim 1, wherein the stop (2.2) is formed by a step, created by a discontinuity in diameter, in the inner wall (2.1) of the housing (2).

4. The reverse-flow throttle valve in accordance with claim 2, wherein the stop (2.2) is formed by a step, created by a discontinuity in diameter, in the inner wall (2.1) of the housing (2).

5. The reverse-flow throttle valve in accordance with claim 1, wherein one inlet opening (bore 2.4) and one outlet opening (2.5) are provided in each of the end walls of the housing (2).

6. The reverse-flow throttle valve in accordance with claim 2, wherein one inlet opening (bore 2.4) and one outlet opening (2.5) are provided in each of the end walls of the housing (2).

7. The reverse-flow throttle valve in accordance with claim 3, wherein one inlet opening (bore 2.4) and one outlet opening (2.5) are provided in each of the end walls of the housing (2).

8. The reverse-flow throttle valve in accordance with claim 1, further comprising at least one throttle bore (6) provided in the housing (2), and wherein the throttle bore (6) is located above the maximal working position of the ball (5), which position is defined by the stop (2.2).

9. The reverse-flow throttle valve in accordance with claim 2, further comprising at least one throttle bore (6) provided in the housing (2), and wherein the throttle bore (6) is located above the maximal working position of the ball (5), which position is defined by the stop (2.2).

10. The reverse-flow throttle valve in accordance with claim 3, further comprising at least one throttle bore (6) provided in the housing (2), and wherein the throttle bore (6) is located above the maximal working position of the ball (5), which position is defined by the stop (2.2).

11. The reverse-flow throttle valve in accordance with claim 5, further comprising at least one throttle bore (6) provided in the housing (2), and wherein the throttle bore (6) is located above the maximal working position of the ball (5), which position is defined by the stop (2.2).

12. The reverse-flow throttle valve in accordance with claim 8, wherein at least three throttle bores (6) are provided, which are disposed at equal angular spacings on the housing jacket.

13. The reverse-flow throttle valve in accordance with claim 1, wherein the diameter (D) of the housing (2) of the reverse-flow throttle valve (1) is between about 3.5 mm and 6.5 mm.

14. The reverse-flow throttle valve in accordance with claim 1, wherein the diameter (D) of the housing (2) of the reverse-flow throttle valve (1) is about 5 mm.

15. The reverse-flow throttle valve in accordance with claim 1, wherein the length (L) of the housing (2) is between about 12 mm and 18 mm.

16. A reverse-flow throttle valve (RDV2), comprising
a substantially cup-shaped valve holder (70) having one inlet opening (73) and one outlet opening (75),
closure means (72) for the inlet opening (73), and
a likewise substantially cup-shaped stroke limiter (71) disposed in the valve holder (70) and defining in an intermediate chamber (77) between the cup bottom of the valve holder (70) and of the stroke limiter (71), the closure means (72) being disposed in the intermediate chamber (77).

17. The reverse-flow throttle valve (RDV2) in accordance with claim 16, wherein the closure means (72) is embodied in the form of a small plate.

18. The reverse-flow throttle valve in accordance with claim 16, wherein the closure means (72) is embodied in the form of a small plate, and further comprising bores (73, 74, 76) that are aligned with one another and disposed in the closure means (72) and in the cup bottoms of the valve holder (70) and the stroke limiter (71).

19. The use of a reverse-flow throttle valve (1, RDV2) in accordance with claim 1, in a high-pressure injection system for fuel.

20. A high-pressure injection system for fuel, comprising
a high-pressure line (rail 30),
at least one fuel injector (35) and one injector line (33) between the rail (30) and the fuel injector (35), and
a reverse-flow throttle valve (1, RDV2), disposed in the fuel flow between the rail (30) and the fuel injector (35), the reverse-flow throttle valve (1, RDV2) being integrated with the rail (30).

21. The high-pressure injection system in accordance with claim 20, wherein the reverse-flow throttle valve (1, RDV2) is disposed in a through bore (32) made in the rail (30).
